(19) United States
(12) Patent Application Publication
(10) Pub. No.: US 2025/0182913 A1
(43) Pub. Date: Jun. 5, 2025

(54) HANDLING OF FORCES ON TOKAMAK TOROIDAL FIELD COILS

(71) Applicants: Massachusetts Institute of Technology, Cambridge, MA (US); Commonwealth Fusion Systems LLC, Devens, MA (US)

(72) Inventors: Brian LaBombard, Belmont, MA (US); Alexey Radovinsky, Cambridge, MA (US); Daniel Brunner, Savannah, GA (US); Christopher J. Lammi, Lynnfield, MA (US); Robert Mumgaard, Boston, MA (US); Nicoli Ames, Woburn, MA (US); Frank Kan, Lexington, MA (US); Valeria Riccardo, Monmouth Junction, NJ (US); Edwin Bolz, Ocean Isle Beach, NC (US)

(73) Assignees: Massachusetts Institute of Technology, Cambridge, MA (US); Commonwealth Fusion Systems LLC, Devens, MA (US)

(21) Appl. No.: 18/727,535

(22) PCT Filed: Jan. 20, 2023
(86) PCT No.: PCT/US2023/060950

§ 371 Date: Jul. 9, 2024

Related U.S. Application Data
(60) Provisional application No. 63/301,611, filed on Jan. 21, 2022.

(51) Int. Cl. G21B 1/05; G21B 1/11; H01F 6/06

(52) U.S. Cl. CPC G21B 1/057; G21B 1/11; H01F 6/06

(57) ABSTRACT

Some aspects relate to a toroidal field (TF) coil for a tokamak. The TF coil includes a first inner leg having teeth on a side of the first inner leg. The corresponds to an interface between the TF coil and a second TF coil. The teeth extend along a direction having a component in a radial direction of the tokamak. The teeth are configured to mechanically engage with second teeth of a second inner leg of the second TF coil.

### CROSS REFERENCE TO RELATED APPLICATIONS

The present application claims the benefit under 35 U.S.C. § 119 (e) of provisional application 63/301,611, filed Jan. 21, 2022, titled “STRUCTURE FOR HANDLING INDUCTIVELY PROPAGATING QUENCH IN TOROIDAL MAGNETS,” which is hereby incorporated by reference in its entirety.

### FIELD

The apparatus and techniques described herein relate to handling asymmetric forces on electromagnets (coils) arranged in a toroidal configuration, and in particular to the handling of such forces in tokamak reactors.

### BACKGROUND

Fusion energy is a possible solution to the need for clean energy. Fusion energy is safe, energy-dense and produces no greenhouse gas emissions. In a fusion reaction, light atomic nuclei such as hydrogen, are combined to form heaver nuclei, such as helium, while producing energy.

### SUMMARY

Some aspects relate to a toroidal field (TF) coil for a tokamak. The TF coil includes a first inner leg having teeth on a side of the first inner leg. The corresponds to an interface between the TF coil and a second TF coil. The teeth extend along a direction having a component in a radial direction of the tokamak. The teeth are configured to mechanically engage with second teeth of a second inner leg of the second TF coil.

The direction may be a radial direction of the tokamak.

The direction additionally may have a component in a vertical direction of the tokamak.

The component may be a positive component and the TF coil may further include third teeth on the side of the first inner leg extending along a direction having a component in a radial direction of the tokamak and a negative component in the vertical direction of the tokamak.

The TF coil may have a metal case, and the teeth may form a surface of the metal case at the side of the first inner leg.

The metal case may comprise steel.

The teeth may have a rounded shape.

The first inner leg may have third teeth on a second side of the first inner leg.

The teeth may be configured to engage with the second teeth when the TF coil and the second TF coil are energized.

Some aspects relate to a tokamak, including: a plurality of toroidal field (TF) coils, including: a first TF coil having a first inner leg having first teeth on a side of the first inner leg, the first teeth extending along a direction having a component in a radial direction of the tokamak; and a second TF coil having a second inner leg having second teeth on a side of the second inner leg. The first teeth may be configured to mechanically engage with the second teeth.

The direction may be a radial direction of the tokamak.

The direction additionally may have a component in a vertical direction of the tokamak.

The component may be a positive component and the first TF coil may further include third teeth on the side of the first inner leg. The third teeth may extend along a direction having a component in a radial direction of the tokamak and a negative component in the vertical direction of the tokamak.

The first TF coil may have a metal case, and the first teeth may form a surface of the metal case at the side of the first inner leg.

The metal case may comprise steel.

The teeth may have a rounded shape.

The first inner leg may have additional teeth on a second side of the first inner leg.

The first teeth may be configured to engage with the second teeth when the TF coil and the second TF coil are energized.

The first inner leg and the second inner leg may be configured to contact a central solenoid when the first and second TF coils are energized.

The teeth or first teeth may extend along the side of the first inner leg for a majority of a vertical extent of the first inner leg.

Some aspects relate to method of forming a toroidal field (TF) coil for a tokamak. The method includes machining teeth on a side of an inner leg of the TF coil. The teeth extend for a majority of a vertical extent of the first leg. The teeth extend along a direction that extends between an inner side of the inner leg and an outer side of the inner leg.

The inner leg may comprise a portion of a metal case of the TF coil. The machining may comprise machining the teeth into the metal case at the side of the inner leg.

Some aspects relate to a method for partial assembly of a tokamak. The method includes positioning a first toroidal field (TF) coil and a second TF coil spaced apart from each other and from a central solenoid structure of the tokamak, with first teeth of a first inner leg of the first TF coil facing second teeth of a second inner leg of the second TF coil.

The method may be performed such that, when the first and second TF coils are energized for operation of the tokamak, the first and second teeth engage with one another and the first and second TF coils contact the central solenoid structure.

The foregoing summary is provided by way of illustration and is not intended to be limiting.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing.

FIG. 1 is a perspective view of a tokamak fusion reactor.

FIG. 2 shows a top view of a bucked design of a tokamak when the TF coils are not energized.

FIG. 3 shows a top view of the bucked design of FIG. 2 when the TF coils are energized.

FIG. 4 illustrates a plurality of TF coils disposed about a central solenoid, and having one or more layers of windings.

FIGS. 5A and 5B show additional detail of the inner leg teeth, according to some embodiments.

FIGS. 5C and 5D show details of the teeth, according to some embodiments.

FIG. 6 shows a view of one example of a TF coil inner leg from the perspective of the central solenoid.

FIG. 7A schematically illustrates teeth that extend in a radial direction, as in the example of FIG. 6.

FIG. 7B schematically illustrates another example of teeth having a “herringbone pattern” with teeth extending along a direction that has both a radial component and a vertical component.

FIG. 8 illustrates an assembled TF coil.

FIG. 9 shows results of a simulation illustrating the stresses produced by significant out of plane deformation of a TF coil.

### DETAILED DESCRIPTION

Magnetic confinement is an approach to generate fusion power that uses magnetic fields to confine a plasma to produce conditions under which the plasma will undergo fusion. Very high plasma temperatures, on the order of 150 million° C., are needed to initiate fusion reactions, and the plasma may be heated through operation of the magnetic fields and using external heating methods. Magnetic confinement of a plasma is challenging, as turbulence, instabilities, and other effects within the plasma can quickly reduce the efficiency of the fusion reaction, or even stop it completely.

The reactor design known as a tokamak is one approach to magnetic confinement that seeks to address the problematic instabilities that can result in the plasma during heating and/or during fusion reactions. In a tokamak, the plasma is confined in a toroid, and instabilities in the plasma are controlled by arranging magnetic fields to cause particles of the plasma to transit between the inner and outer sides of the toroid multiple times per orbit. To control the plasma in a tokamak, magnets are used to create toroidal and poloidal fields that shape and position the plasma within the toroid, as well as drive motion of the plasma around the toroid.

No previous magnetic confinement fusion device has demonstrated a gain greater than 1, which is a necessary step to commercializing magnetic confinement fusion devices as a viable energy source. The fusion performance of a tokamak can be improved by increasing the magnetic field strength or increasing the size of the tokamak. Increasing the size of a tokamak may require a great deal of infrastructure and lead to high costs. Accordingly, it would be desirable to keep the size of a tokamak reactor small while increasing the magnetic field to improve performance. Magnets capable of achieving high magnetic field strengths have been demonstrated using cryogenically cooled high-temperature superconductor (HTS), which may be in the form of HTS tape.

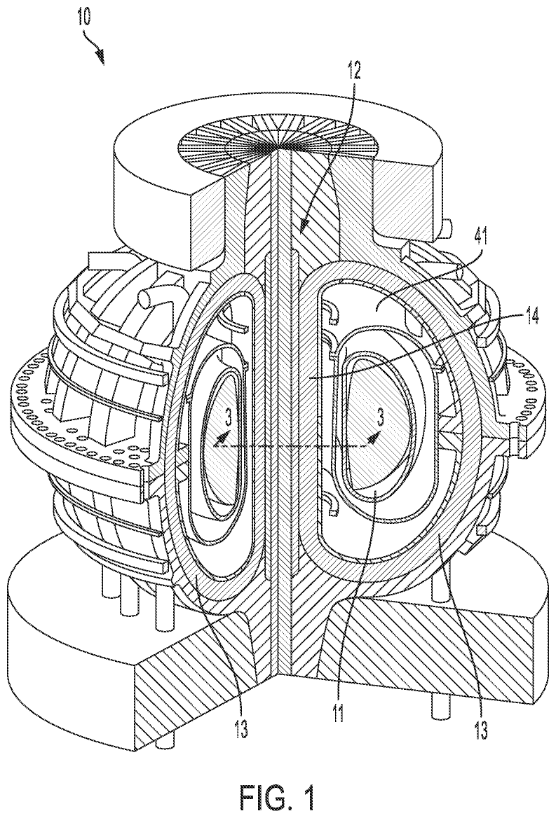

FIG. 1 is a perspective view of a tokamak fusion reactor 10 comprising a vacuum vessel 11. The vacuum vessel 11 is disposed in a radiation shield (or “shield tank”) 41. Vacuum vessel 11 and radiation shield 41 are disposed about a central solenoid 12. Toroidal field (TF) coils 13 are disposed about vacuum vessel 11. As illustrated, the TF coils 13 each may have a D-shape. Other shapes may be used. The body of the TF coils 13 may be formed from a conductive metal, often in the form of a baseplate having one or more superconducting current paths formed from HTS tape within the baseplate. The HTS tape may wind around the body of the baseplate one or more times. Electric current is provided to the HTS coil 13 to generate a high-strength magnetic field. The conducting channel through the baseplate may also have (in addition to the HTS tape) a conductive material (sometimes referred to as a “co-wind”) disposed therein. In some embodiments, a conductor may be disposed over the HTS as a cap. According to some embodiments, the HTS may comprise a rare earth barium copper oxide superconductor (REBCO), such as yttrium barium copper oxide (YBCO). In some embodiments, the HTS coils 13 may include a plurality of layers of windings arranged in a stack. In this arrangement, each layer of windings may be referred to as a “pancake” and the stacked plurality of layers of windings may be referred to as a “stack of pancakes.”

The inventors have recognized and appreciated the need to handle large forces that can arise in a tokamak reactor. For example, high magnetic field strengths lead to large Lorentz forces on the conductors. Although forming magnets in high-strength metal structures may stabilize the conductors in the presence of a static field, the inventors have recognized and appreciated that transient events in the tokamak may produce large asymmetric forces on the TF coils 13. One example of such a transient event is a “tsunami” quench that propagates inductively around the tokamak. In a tsunami quench, the transition of one TF coil from a superconducting state to a non-superconducting state produces a change in the magnetic field that affects a neighboring TF coil, causing it to quench, which may, in turn, cause its neighboring TF coil to quench, and the process may continue around the circumference of the tokamak in a quench “tsunami.” Another example of a transient event is the during the “shot” in which plasma is formed in the vacuum vessel 11. Interaction between the time-varying magnetic fields produced by the central solenoid (CS) with the currents of the TF coils 13 may create so-called Out-of-Plane (OOP) forces, tending to deform the inner leg 14 of the TF coil (closest to the CS 12) in the circumferential direction, tangentially to the cylindrical interface between the inner leg 14 inner surface and the CS 12 outer surface.

Such events can produce large asymmetric forces on the TF coils 13 which may cause them to bend and/or twist from their nominal in-plane shape. Accordingly, the inventors have recognized and appreciated there is a need for bracing or otherwise mechanically stabilizing the TF coils 13 to make them resilient to transient events.

During operation of the TF coils 13 their magnetic fields produce forces that push the TF 13 coils toward the center of the tokamak. These forces may be dealt with by using different approaches. One technique is termed “wedging” and may be referred to as a “wedged” design. In a wedged design the TF coils 13 are designed to press up against one another as they press toward the interior of the tokamak, which distributes forces from one TF coil to another, in the circumferential direction of the tokamak. Another technique is termed “bucking” and may be referred to as a bucked design. In a bucked design the TF coils press up against a central structure of the tokamak, such as the CS. The two techniques are not mutually exclusive, and some designs rely on a combination of both techniques, which may distribute forces circumferentially and radially in different proportions depending on the design.

The inventors have recognized and appreciated that a primarily “bucked” design is preferable for creating a small tokamak reactor, for a number of reasons. First, a primarily bucked design distributes forces toward the center of the tokamak, away from the winding pack of the TF coils, which helps to avoid strain on the winding pack. Second, a primarily bucked design may serve a secondary purpose, which is to counter the expansion forces produced by the central solenoid. A primarily bucked design helps to avoid the need for a containment structure to absorb the expansion forces produced by the central solenoid, which helps in keeping the size of the tokamak small.

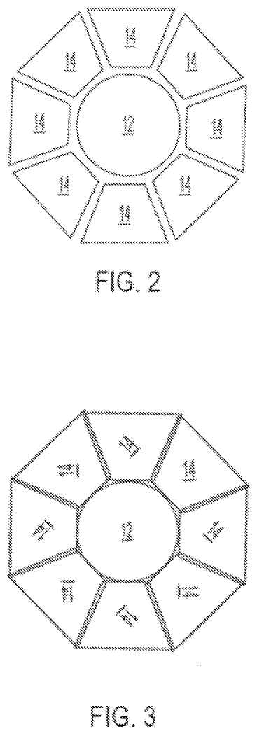

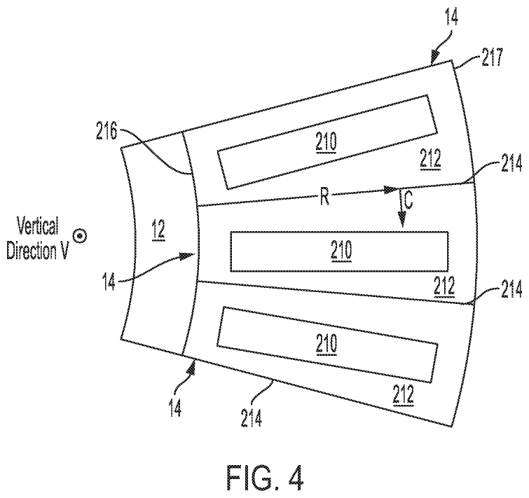

FIG. 2 shows a top view of a bucked design when the TF coils are not energized. As shown in FIG. 2, the inner legs 14 of the TF coils are spaced apart from one another and from the CS 12. FIG. 3 shows a top view when the TF coils are energized. The inner legs 14 primarily press up against CS 12 and also press against each other as they move inward toward the CS 12.

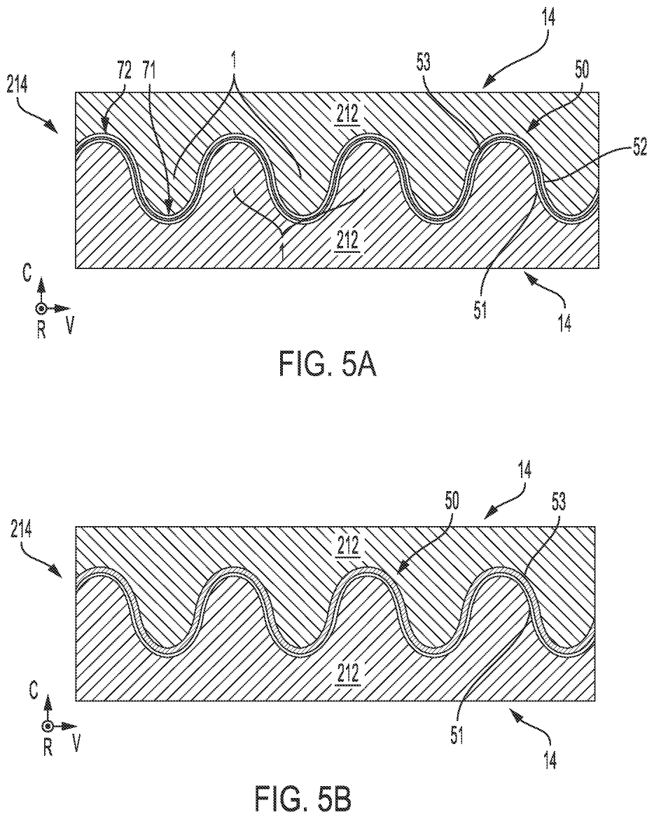

Additional detail of the TF coils inner legs 14 and their interfaces with other structures are shown in FIG. 4. As shown in FIG. 4, a plurality of TF coils are disposed around a central solenoid (CS) 12 with their inner legs 14 contacting one another. TF coils 13 each include one or more layers of windings 210 extending through the inner legs 14. As shown, the inner legs 14 which may have a wedge shape. The one or more layers of windings 210 may be encased in a structural case 212 of the TF coil 13. Between adjacent coils is a TF-to-TF interface 214. Between the inner leg 14 of a TF coil 13 and the CS 12 is a TF-to-CS interface 216 at an inner side of the inner leg 14. The TF-to-TF interface 214 and the TF-to-CS interface 216 may have an electrically insulating material insulating the TF coils 13 from one another and from the CS 12. Such insulation may impede the formation of eddy currents which may lead to excess heating. The outer side 217 of each inner leg 14 faces the outer leg of the TF coil (as can be seen in FIG. 1) in a radial direction R of the tokamak.

As mentioned above, the inventors have recognized and appreciated there is a need for bracing or otherwise mechanically stabilizing the TF coils to make them resilient to transient events. In some embodiments, the inner legs 14 of the TF coils 13 may be designed to press up against one another when they are energized, as shown in FIG. 4, and structures may be positioned at the surfaces of adjacent TF inner legs that mechanically engage with one another. More particularly, in accordance with some embodiments, sides of the inner leg 14 facing an inner leg of an adjacent TF coil may have “teeth” at the TF-to-TF interface 214 that extend along the sides of the inner legs. When the inner legs of the TF coils 13 press up against one another, the teeth of the legs 14 of the adjacent TF coils 13 engage with one another, which provides load sharing between toroidal field magnets. The teeth may have roots and crests extending a radial direction (direction R of FIG. 4) or in a direction that has both a radial component and a vertical component (into or out of the page in FIG. 4), as discussed further below.

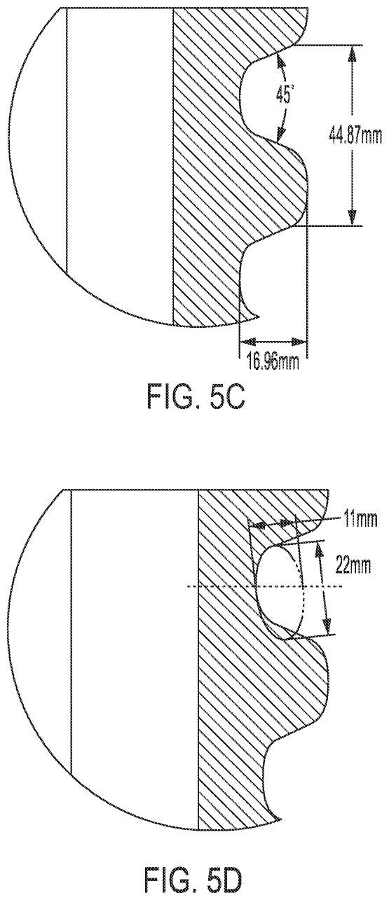

FIGS. 5A and 5B show additional detail of the inner leg teeth 1, according to some embodiments. The radial dimension of FIG. 4 corresponds to the direction out of the page of FIG. 5A and FIG. 5B. The vertical direction V and the circumferential direction C of FIG. 4 are also labeled in FIG. 5A and FIG. 5B. As can be seen in FIG. 5A, the case 212 of each inner leg 14 has teeth 1 at the interface 214 with the inner leg 14 of the adjacent TF coil 13, and mechanically engage corresponding teeth 1 of the adjacent inner leg 14. The teeth 1 have roots 71 and crests 72 that are complementary to those of the adjacent inner leg 14. The engagement of the teeth of adjacent inner legs 14 helps to absorb and distribute forces such as those caused by transient events in the tokamak, which may help to prevent deformation and vertical movement of the TF coils 13. The teeth 1 may correspond to the side of the case 212, and may be formed by machining the side of the case 212. The case 212 may be a forged metal (e.g., steel) that is subsequently machined (e.g., milled) to form the teeth 1. During the plasma “shot” the TF coils 13 may experience large electromagnetic forces, tending to cause slippage along the sidewalls of the TF coil cases 212 at the TF-to-TF interface 214. This slippage is impeded by the engagement of the teeth 1, which restricts movement of adjacent TF coils past one another in a vertical direction. The teeth 1 may also help to prevent deformation of the TF coils 12 in a circumferential direction due to transient forces. Having teeth 1 extend in a radial direction allows adjacent TF coils to move relative to one another along the radial direction R, allowing the TF coils to buck up against the CS 12 when they are energized.

To prevent electrical currents, such as eddy currents, from flowing across the TF-to-TF interface 214, insulating material 53 may be disposed between the teeth 1 of adjacent cases 212. The insulating material 53 may comprise a polymer material, such as a polyimide material, but is not limited to polyimide or polymer materials. Since the insulating material may be subject to significant grinding and crushing forces, in some embodiments an interface structure at the TF-to-TF interface 214 may also comprise one or more metal sheets.

FIG. 5A shows an example in which portions of a pair of TF coil cases 212 may abut each other over radial-axial planes. As noted above, during plasma generation TF coils incur large electromagnetic forces, tending to cause slippage along sidewalls of TF coil cases. This slippage may be contained by shaping sidewalls of the TF cases 212 as teeth 1, as shown in FIG. 5A. To prevent a continuous electrically conducting loop from being formed by the TF cases around all the TF coils and consequently high resistive heating caused by eddies induced in this loop by the time-variable fields from CS and PF coils, an interface structure 50 may be disposed between at least portions of the teeth 1 of TF coil cases 212 at the TF-to-TF interface 214. In embodiments, interface structure 50 can be either deposited, attached or otherwise disposed on at least a portion of a surface of one or more TF coil case teeth 1. In embodiments, interface structure 50 may be provided as a separate corrugated sheet, installed or otherwise disposed between the TF coil teeth 1.

FIG. 5A shows an example in which interface structure 50 comprises insulating material 51 and 52 (which may be provided as insulating sheets of material such as an anodized metal such as an anodized metallic sheet, for example) positioned or otherwise disposed on either side of a metal material 53. In embodiments the insulating material 51 and 52 and metal material 53 may be laminated so as to provide interface structure 50 as a laminated insultation. The insulating material 51 and 52 and metal material 53 are disposed between the teeth 1. Thus, teeth 1 may be in contact with insulating material (e.g. insulating sheets 51 and/or 52).

FIG. 5B shows an example in which interface structure 50 comprises a metal sheet 53 positioned or otherwise disposed on one surface of insulating material 51. In this embodiment, an opposing surface of insulating material 51 is directly in contact with the teeth 1.

In other embodiments, the TF-to-TF interface 214 may include additional layers of insulating material and/or metal sheets. In some embodiments where the insulating material 51/52 is sufficiently robust, the TF-to-TF interface 214 may include no metal sheets. Instead, the insulating material 51/52 may contact the teeth 1 on both TF cases 212, for example.

The insulating material 51/52 may be provided in any suitable thickness such as 0.01 mm to 1 mm, for example, e.g., 0.1 mm. The insulating material 51/52 may have a suitable standoff voltage, such as greater than 1 V, greater than 10V, or greater than 100 V or 1 kV, for example. As noted above, the insulating material (e.g. insulating material 51) may be provided from one or more insulating sheets. At least some or even all of the one or more sheets may have any suitable thickness such as 0.01 mm to 1 mm, for example, e.g., 0.1 mm. Furthermore, some or all of the insulating sheets may have a suitable standoff voltage, such as greater than 1 V, greater than 10V, or greater than 100 V or 1 kV, for example. However, these are examples, and the insulating material is not limited to particular thicknesses or standoff voltages.

The one or more metal sheets 53 may each have a thickness ranging between about 0.1 mm to about 2.0 mm, or 25-50 microns, in some cases. However, these are examples, and the metal sheets are not limited to particular thicknesses. In some embodiments, layer 53 may be provided as an insulating material.

The teeth 1 may be designed in consideration of both tensile loading in the inner leg 14 and the local shear forces. In one particular design, the teeth may have an included angle of 45-degrees, a pitch of 44.87 mm, and a depth of 16.96 mm, as illustrated in FIG. 5C. The teeth 1 may have an elliptical profile, with a major radius of 11 mm and minor radius of 5.5 mm (2:1 aspect ratio), as shown in FIG. 5D. The ellipse is rotated relative to the inner leg while enforcing tangency to the included angle of the teeth walls and tangency at the root of the teeth. However, this is an example, and the teeth 1 may have different included angles, pitches, depths, profiles, or shapes, as the structures and techniques described herein are not limited in this respect.

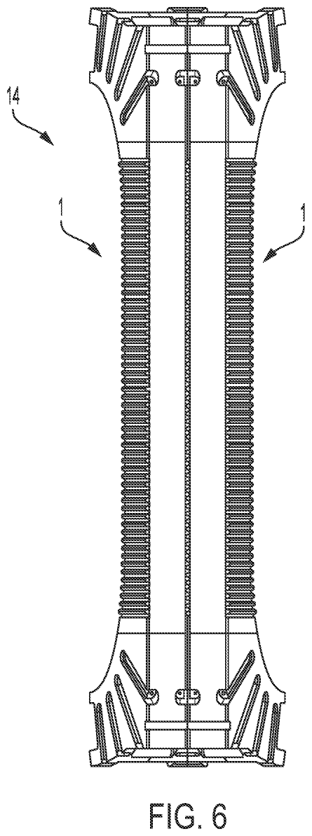

FIG. 6 shows a view of one example of a TF coil inner leg 14 from the perspective of a viewpoint looking out from the CS 12. As can be seen in FIG. 6, the two sides of the inner leg 14 facing adjacent TF coil inner legs have teeth 1 extending in a radial direction. In this example, the teeth 1 extend in the radial direction and do not have a component extending in the vertical direction. FIG. 6 also illustrates that the teeth 1 may be formed over a majority of the surface of the TF-to-TF interface 214. In this example, the teeth 1 extend over an area corresponding to the vertical extent of the straight (e.g., non-curved) portion of the inner leg 14. Further, the teeth may extend across the entire radial extent of the TF-to-TF interface or a majority thereof. However, the teeth 1 may extend over larger or smaller extents in the vertical and/or radial direction.

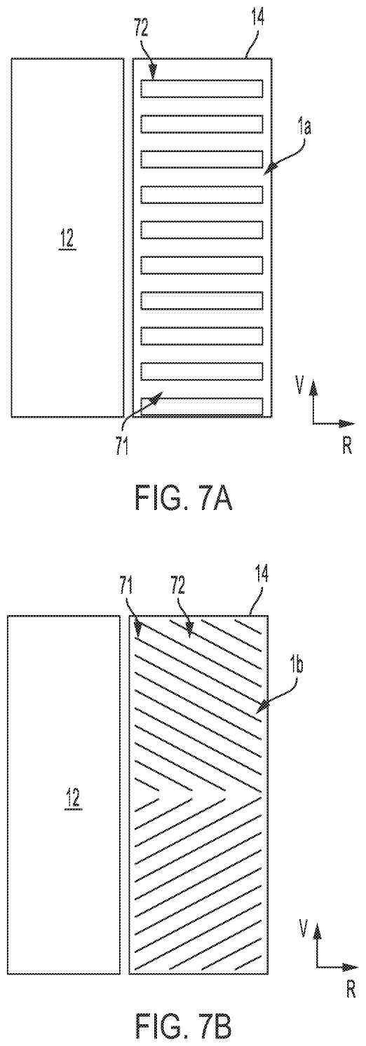

FIG. 7A schematically illustrates teeth 1a that extend in a radial direction, as in the example of FIG. 6. The roots 71 and crests 72 of the teeth 1a extend horizontally in FIG. 7A along the radial direction R, and do not have a component in the vertical direction V. The CS 12 is also shown to the inside of the inner leg 14.

FIG. 7B schematically illustrates another example of teeth 1b having a “herringbone pattern” with teeth 1b extending along a direction that has both a radial component and a vertical component. In the top half of FIG. 7B, which corresponds to the top half of inner leg 14, the roots 71 and crests 72 of the teeth 1b extend in a direction that has both an upward vertical component and a radial component. In the bottom half of FIG. 7B, corresponding to the bottom half of inner leg 14, the roots 71 and crests 72 of the teeth extend in a direction that has both a downward vertical component and a radial component. As described above with respect to radial teeth, the teeth in a herringbone pattern may be configured to mechanically engage with complementary teeth on the adjacent inner leg. Providing teeth having a herringbone pattern may restrict both vertical and horizontal slippage of adjacent TF coils.

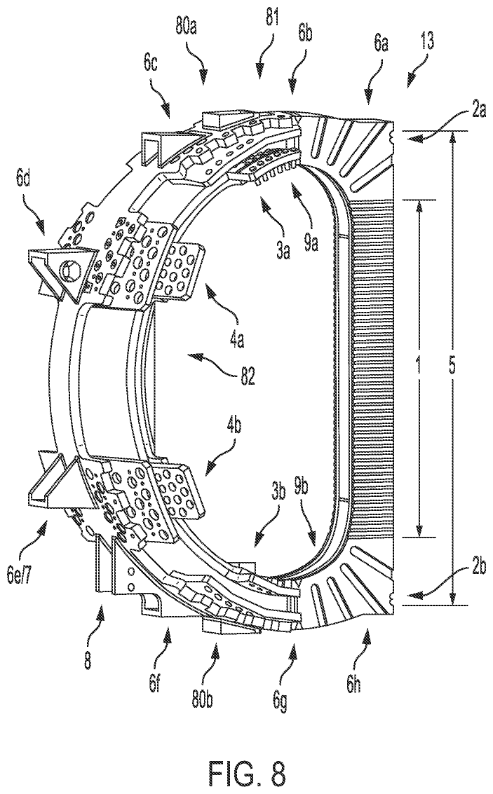

An assembled TF coil 13 is illustrated in FIG. 8. Load mitigation features include: TF coil inner leg teeth 1; radial shear keys 2a and 2b in the elliptical arc connecting the inner and outer legs of the TF coils 13; the inner inter coil structure 3a and 3b; and the outer intercoil structure 4a and 4b. The radial shear keys may be insertable keys with a rectangular cross section. The inner and outer intercoil structures are top-down symmetric and have an upper and lower assembly. Both sets of intercoil structures include inner and outer plates, connected by a radial plate.

Device integration locations include: the structural interface 5 with the central solenoid 12, which includes a “bucking region”; attachment points 6a-6h for poloidal field (PF) coils including attachment points PF1 upper 6a, PF2 upper 6b, PF3 upper 6c, PF4 upper 6d, PF4 lower 6e, PF3 lower 6f, PF2 lower 6g, and PF1 lower 6h; gravity support 7 for the vacuum vessel; gravity support 8 for the TF coil and attached subsystems; attachment of the divertor coils at 9a and 9b; connections to the cryogenic cooling distribution system 80a-80b; connections 81 to electrical feed and intermagnet electrical connections; and connections 82 to the error field correction coils. All device integration features may be welded to the inner poloidal ring and outer poloidal assemblies prior to final assembly and welding of the TF coil 13.

Radial and vertical forces and bending about the toroidal axis (in-plane loads) are mitigated by the “bulk” of the TF coil 13 and bucking provided by the interface with the central solenoid 12. In-plane loads manifest as membrane, bending, and contact forces within the TF coil 13. The mitigation of the radial forces on the TF coil 13 by bucking, opposed to wedging, creates a more favorable effective stress state, compatible with existing structural engineering materials. The inner leg teeth 1 facilitate a bucked design, because local features are necessary on the inner leg to intercept loads. The section thickness of the TF coil 13 is designed to sustain the remainder, and majority, of the membrane and bending loads. The toroidal forces are not mitigated by the bulk structure of the toroidal magnets nor the bucking pressure of the central solenoid. The load mitigation features 1-4b are largely responsible for this as well as being responsible for load sharing of local, dynamic, differences of in-plane loads to neighboring magnets.

The inner leg teeth 1 provide vertical load sharing between neighboring TF coils 13. They serve to limit displacement and strain of a coil undergoing a peaking of current, as its two neighbors are close to nominal current and at significantly reduced current. Engagement of the teeth due to local differences in vertical load in the inner leg is most pronounced at the “top” and “bottom” of the inner leg assuming a uniform tooth spacing, gaps, and tolerances. As a result, high toroidal-vertical shear forces and stresses are observed in this region of active tooth engagement. The section thickness of the inner leg of the TF coil 13 can be designed considering these shear forces. Here, the TF coil 13 winding pack is “bent,” providing more section thickness at the area of high bending than at the midplane of the inner leg, and follows a circular arc. Due to large radial displacements of the inner leg, resulting from an imbalance of radial load exerted on the central solenoid, the inner leg radial teeth also actively engage close to the inner leg vertical midplane. Engagement in the region of the inner leg vertical midplane increases effective bending stiffness about the radial and toroidal axes and limits toroidal and radial displacements of the inner leg. Tooth gaps and tolerances may be designed with this consideration as it defines interface requirements at the interface with the central solenoid 12.

The radial shear keys 2a and 2b, primarily serve to provide radial load sharing between neighboring coils and maintain the “circular” shape of the TF coil 13 during a transient event such as an inductively coupled quench. The keys closest to the inner leg radial leg also aid in vertical load sharing and contribute to the high shear forces observed at the top and bottom of the inner leg.

The inner intercoil structure, features 3a and 3b, and the outer intercoil structure, features 4a and 4b, transfer imbalanced toroidal forces to neighboring coils. The inner intercoil structure and outer intercoil structure also serve to transfer radial and vertical loads between neighboring TF coils 13, respectively. These forces are compressive and carried by insertable shear pins. Each pin may be loaded in double shear. A radial segment, or plate, connects the inner and outer plates of the inner and outer intercoil structure to reduce bending loads on the plates themselves and bending on the pins. The plates are held in place with bolts, which carry a negligible amount of toroidal load compared to the much larger pins.

One notable attribute of interfacing systems with the TF coil 13 is their displacement compatibility. The central solenoid 12 and interface with the TF coils is compatible with the radial displacements of the TF coil 13. Interfaces with the poloidal magnets, features 6a-6h; gravity support with the vacuum vessel, feature 7; the diverter coil magnet, features 9a and 9b; connections to the cryogenic cooling distribution system 10a-10b; connections to electrical feed and intermagnet electrical connections 11; and connections to the error field correction coils 12 are compatible with the toroidal displacements of the TF coil 13 and differential vertical and radial expansion between neighboring structures via the use of flexible attachments and joints. Similarly, but to a lesser extent, the vacuum vessel gravity supports, feature (8), also accommodate toroidal displacement of the magnets and differences in radial and vertical displacements between adjacent magnets.

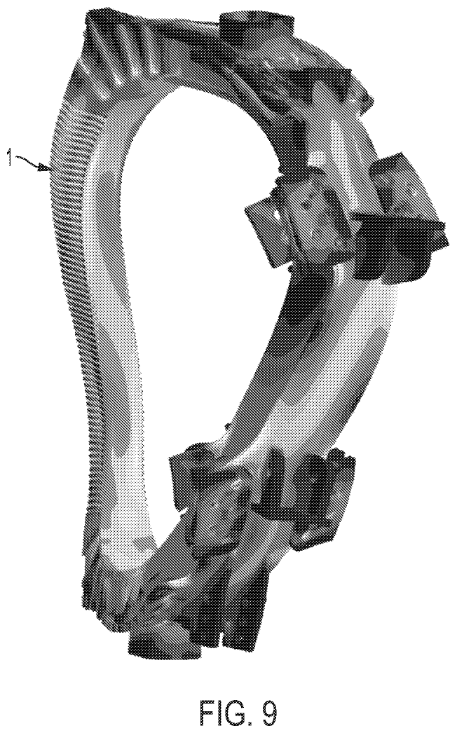

FIG. 9 shows results of a simulation illustrating the stresses produced by significant out of plane deformation of a TF coil 13. The teeth 1 help to absorb the stresses and transfer them to neighboring TF coils through engagement of teeth 1 on the adjacent TF coil (not shown).

While several embodiments of the concepts described herein have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the concepts described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the concepts described herein is/are used. Those skilled in the art will recognize, or be able to ascertain using no more than routine experimentation, many equivalents to the specific embodiments of the concepts described herein. It is, therefore, to be understood that the foregoing embodiments are presented by way of example only and that, within the scope of the appended claims and equivalents thereto, the described concepts may be practiced otherwise than as specifically described and claimed. The concepts described herein relate to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the concepts described herein.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment may include that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. A toroidal field (TF) coil for a tokamak, the TF coil comprising:
a first inner leg having teeth on a side of the first inner leg, the side corresponding to an interface between the TF coil and a second TF coil, the teeth extending along a direction having a component in a radial direction of the tokamak, the teeth being configured to mechanically engage with second teeth of a second inner leg of the second TF coil.

2. The TF coil of claim 1, wherein the direction is a radial direction of the tokamak.

3. The TF coil of claim 1, wherein the direction additionally has a component in a vertical direction of the tokamak.

4. The TF coil of claim 3, wherein the component is a positive component and the TF coil further includes third teeth on the side of the first inner leg extending along a direction having a component in a radial direction of the tokamak and a negative component in the vertical direction of the tokamak.

5. The TF coil of claim 1, wherein the TF coil has a metal case, and the teeth form a surface of the metal case at the side of the first inner leg.

6. The TF coil of claim 5, wherein the metal case comprises steel.

7. The TF coil of claim 1, wherein the teeth have a rounded shape.

8. The TF coil of claim 1, wherein the first inner leg has third teeth on a second side of the first inner leg.

9. The TF coil of claim 1, wherein the teeth are configured to engage with the second teeth when the TF coil and the second TF coil are energized.

10. A tokamak, comprising:
a plurality of toroidal field (TF) coils, including:
a first TF coil having a first inner leg having first teeth on a side of the first inner leg, the first teeth extending along a direction having a component in a radial direction of the tokamak;
a second TF coil having a second inner leg having second teeth on a side of the second inner leg,
wherein the first teeth are configured to mechanically engage with the second teeth.

11. The tokamak of claim 10, wherein the direction is a radial direction of the tokamak.

12. The tokamak of claim 10, wherein the direction additionally has a component in a vertical direction of the tokamak.

13. The tokamak of claim 12, wherein the component is a positive component and the first TF coil further includes third teeth on the side of the first inner leg, the third teeth extending along a direction having a component in a radial direction of the tokamak and a negative component in the vertical direction of the tokamak.

14. The tokamak of claim 10, wherein the first TF coil has a metal case, and the first teeth form a surface of the metal case at the side of the first inner leg.

15. The tokamak of claim 14, wherein the metal case comprises steel.

16. The tokamak of claim 10, wherein the teeth have a rounded shape.

17. The tokamak of claim 10, wherein the first inner leg has additional teeth on a second side of the first inner leg.

18. The tokamak of claim 10, wherein the first teeth are configured to engage with the second teeth when the TF coil and the second TF coil are energized.

19. The tokamak of claim 10, wherein the first inner leg and the second inner leg are configured to contact a central solenoid when the first and second TF coils are energized.

20. The tokamak of claim 10, wherein the teeth or first teeth extend along the side of the first inner leg for a majority of a vertical extent of the first inner leg.

21. A method of forming a toroidal field (TF) coil for a tokamak, the method
comprising:
machining teeth on a side of an inner leg of the TF coil, the teeth extending for a majority of a vertical extent of the inner leg, the teeth extending along a direction that extends between an inner side of the inner leg and an outer side of the inner leg.

22. The method of claim 21, wherein the inner leg comprises a portion of a metal case of the TF coil, and the machining comprises machining the teeth into the metal case at the side of the inner leg.

23. A method for partial assembly of a tokamak, the method comprising:
positioning a first toroidal field (TF) coil and a second TF coil spaced apart from each other and from a central solenoid structure of the tokamak, with first teeth of a first inner leg of the first TF coil facing second teeth of a second inner leg of the second TF coil.

24. The method of claim 23, wherein the method is performed such that, when the first and second TF coils are energized for operation of the tokamak, the first and second teeth engage with one another and the first and second TF coils contact the central solenoid structure.
